(19) United States
(12) Patent Application Publication
(10) Pub. No.: US 2013/0207018 A1
(43) Pub. Date: Aug. 15, 2013

(54) EXTINGUISHING AGENT

(71) Applicants: Thomas Woehrle, Stuttgart-Feuerbach (DE); Stephan Leuthner, Leonberg (DE); Rainer Kern, Stuttgart (DE)

(72) Inventors: Thomas Woehrle, Stuttgart-Feuerbach (DE); Stephan Leuthner, Leonberg (DE); Rainer Kern, Stuttgart (DE)

(73) Assignee: SB LiMotive Company, Ltd., Yongin-si, Gyeonggi-do (KR)

(21) Appl. No.: 13/578,087

(22) PCT Filed: Dec. 21, 2010
(86) PCT No.: PCT/EP10/70363

§ 371 Date: Oct. 16, 2012

(30) Foreign Application Priority Data
Feb. 10, 2010 (DE) 10 2010 001 741.8

(51) Int. Cl. A62D 1/00

(52) U.S. Cl. CPC A62D 1/0064
USPC 252/2

(57) ABSTRACT

An extinguishing agent for firefighting and fire prevention includes a suspension of at least water, a salt which is hardly soluble in water and has a cation of the elements calcium, magnesium, or strontium, and a water thickener. A method for producing the extinguishing agent includes dissolving the water thickener in water, introducing the sparingly soluble salt, and producing a suspension comprising the sparingly soluble salt and the water thickener. A firefighting system includes the extinguishing agent, which is used in firefighting and fire prevention of lithium ion batteries.

The present invention relates to an extinguishing agent, a process for producing it, a fire fighting system using this extinguishing agent and use of this extinguishing agent for fire fighting and fire prevention, in particular for lithium ion batteries.

### PRIOR ART

Many different extinguishing agents and extinguishing methods for different possible uses are known.

Thus, for example, DE 40 12 549 A1 discloses a process for fighting and extinguishing fires and an apparatus for carrying this out, by means of which, on the basis of wet extinguishing, an improved extinguishing effect is said to be achieved while reducing the environmental pollution caused by the extinguishing operation. Here, calcium precipitation products and/or particularly active calcium carbonate, i.e. particularly finely milled or finely divided, environmentally friendly calcium carbonate which is not hazardous to health is used. This is said to seal burning surfaces immediately and interrupt a reaction chain. Toxic gases and pollutants liberated by the thermal decomposition of plastics react with the calcium carbonate and are bound. However, DE 40 12 549 A1 is suitable only for fires of classes A, B and C. Lithium ion batteries cannot be fought according to this prior art.

It is also known that water can be used as extinguishing agent and thickeners or gel formers can be added to the water in order to increase the viscosity. Water having an increased viscosity or water in gel form has a better cooling power.

The terms lithium ion cell, lithium ion battery, lithium ion system, lithium ion battery systems are used synonymously in the following. Here, a lithium ion cell is an electrochemical element which contains at least one electrode which can reversibly release or incorporate lithium ions.

No extinguishing agent which is matched to fighting fires in lithium ion systems is known. Conventional extinguishing agents either have a cooling power which is too low, i.e. they are mostly vaporized ineffectively or they are not able to specifically bind hazardous materials emitted in the case of lithium ion systems and thus prevent them from getting into the environment.

In the case of lithium ion systems, leakage or a fire results in emission of highly reactive and toxic species such as phosphorus oxide trifluoride (POF₃) or hydrofluoric acid (HF). This is due to the fact that the electrolyte salt lithium hexafluorophosphate (LiPF₆) is used in virtually all lithium ion systems or lithium ion polymer systems and gets out when the cell is opened and is converted into highly toxic, corrosive and reactive species. Phosphorus oxide trifluoride (POF₃), phosphoric acid (H₃PO₄) and hydrofluoric acid (HF) can be formed in this case. These species represent a great danger to human beings and the environment.

### DISCLOSURE OF THE INVENTION

The invention provides an extinguishing agent composed of a suspension comprising at least water, a salt which has an alkaline earth metal cation and is sparingly soluble in water and a water thickener.

The extinguishing agent of the invention makes it advantageously possible to prevent a fire in lithium ion systems or to extinguish such a fire after it has arisen. The sparingly soluble salt having an alkaline earth metal cation which is used also binds phosphorus oxide trifluoride, phosphoric acid and hydrogen fluoride. The suspended powder which is finely dispersed in water also advantageously does not, unlike dissolved salts such as calcium chloride CaCl₂, display a competing interaction with the gel former, which would reduce a cooling effect of the extinguishing agent.

The water thickener brings about an increase in the viscosity and gelling of the liquid. The extinguishing agent of the invention therefore has a gel-like consistency. In this way, ineffective vaporization of the water before impingement on a seat of a fire is advantageously prevented and at the same time the gel former itself and the sparingly soluble suspended powder are stable and uniformly distributed in this gel-like extinguishing agent. A change in the viscosity brought about by water thickeners enables the extinguishing agent of the invention to be advantageously matched to a specific application. An example of this prior art is EP1817086B1. According to this prior art, it is not possible to fight lithium ion battery fires since the toxic and corrosive species which are naturally liberated during fighting of the fire with a purely water-based extinguishing agent by hydrolysis of the electrolyte salt lithium hexa fluorophosphate (LiPF₆) are not removed from the atmosphere.

However, it has surprisingly been found that a combination of a water-based gel extinguishing agent with a sparingly soluble salt which has a cation based on calcium, magnesium or strontium and reacts with hydrogen fluoride (HF) to form a fluoride salt which insoluble in water is suitable for fighting lithium ion fires. The gel extinguishing agent provides a sufficient cooling effect and the reactive salt chemically binds the hydrogen fluoride and further toxic species which can be formed.

In addition, the extinguishing agent of the invention can be used in a variety of extinguishing systems, for example in stationary high-pressure mist systems for lithium ion test benches, manual fire extinguishers or transport containers from which extinguishing agent is supplied in the case of danger. In a particular embodiment, calcium carbonate (CaCO₃) is the sparingly soluble salt having an alkaline earth metal cation. The use of calcium carbonate or lime advantageously represents the use of a comparatively inexpensive and environmentally friendly substance. Calcium carbonate binds hydrogen fluoride (HF) to form calcium fluoride (CaF₂) which is sparingly soluble in water.

In a further particular embodiment, the extinguishing agent comprises the sparingly soluble salt in a proportion in the range from 5% by weight to 30% by weight. In the case of fire fighting or fire precautions, this ratio advantageously provides an amount of reactive, sparingly soluble salt by means of which virtually all pollutants such as hydrogen fluoride can be bound.

In a further particular embodiment, the sparingly soluble salt has an average particle size in the range from 0.2 μm to 10 μm. This advantageously provides a particle size of the sparingly soluble salt with which the sparingly soluble salt has an optimally large surface area for rapidly binding the harmful species by chemical reaction.

The extinguishing agent of the invention is preferably implemented in all its embodiments in a fire fighting system.

The invention likewise provides a fire fighting system comprising an extinguishing agent of the above-described type. In this way, a system by means of which lithium ion systems can also be effectively extinguished in an environmentally friendly way is advantageously provided.

The invention likewise provides a process for producing the extinguishing agent and a use of an extinguishing agent of the above mentioned type. In this way, a use for fire fighting and fire prevention which can be realized by means of known fire protection systems or extinguishing systems is advantageously provided.

In a particular embodiment, a lithium ion battery is extinguished. In this way, hazardous materials such as phosphorus oxide trifluoride (POF₃), phosphoric acid (H₃PO₄) or hydrogen fluoride (HF) are advantageously prevented from getting into the environment. As a result of the use of a sparingly soluble salt having an alkaline earth metal cation, no free fluoride anion can be detected in the extinguishing water after an extinguishing operation.

Advantageous embodiments of the invention are indicated in the dependent claims and described in the description.

### EMBODIMENTS OF THE INVENTION

The extinguishing agent of the invention is based on water as basis, a salt which has an alkaline earth metal cation and is sparingly soluble in water, for example a carbonate, in order to bind, for example, hydrogen fluoride formed or phosphorus oxide trifluoride (POF₃) by means of a chemical reaction and a thickener, as a result of which the extinguishing agent is given a relatively high viscosity and thus a gel-like consistency. A water-based gel has an increased cooling effect. This results from the fact that the water molecules are held to a certain extent by interaction with the gel former and can be separated therefrom only by means of input of additional energy.

As thickeners it is possible to use commercial products, for example Firesorp™. The viscosity of the extinguishing agent of the invention can be matched to the respective intended use via the amount of thickener added. Thus, for example, protective layers of the extinguishing agent which are arranged in containers as a safety precaution can have a relatively great viscosity in order to aid handling of such containers, and extinguishing agents to be sprayed can be given a lower viscosity compared thereto in order to ensure good sprayability.

The increased viscosity compared to normal water results in a better cooling power of the extinguishing agent and in a more homogeneous distribution of the salts present in the extinguishing agent.

According to the invention, lime, i.e. calcium carbonate, is preferably used as salt having an alkaline earth metal cation. The average particle diameter of the salt is in the range from 0.2 μm to 10 μm, preferably 1-2 μm, and the salt is added to the extinguishing agent in a proportion in the range from 5% by weight to 30% by weight, preferably 15% by weight. According to the invention, other salts having the cations magnesium (Mg), calcium (Ca), Strontium (Sr) of main group 2 of the Periodic Table are also provided for, but Be is unsuitable and Ba is too toxic.

A reduction in the particle size enables the surface area provided for reactions and thus the reactivity to be increased. A particle size in the range from 0.2 μm to 10 μm is an optimal size in order to bind the hydrogen fluoride present and other hazardous materials quickly.

In the following, the process of the invention for producing the extinguishing agent is described in more detail. The extinguishing agent of the invention comprising the components a) water, b) sparingly soluble carbonate as fluorine scavenger, c) gel which binds water is dispensed as a suspension of the sparingly soluble carbonate in a viscous extinguishing gel (e.g. Firesorp™). For this purpose, the extinguishing gel, for example Firesorp™, is firstly dissolved in water (for example 2%) and, for example, lime having an average particle diameter of 2 μm is introduced (e.g. 15% by weight).

1. An extinguishing agent composed of a suspension, comprising:
at least water,
a salt which has a cation based on calcium, magnesium or strontium and is sparingly soluble in water, and
a water thickener.

2. The extinguishing agent as claimed in claim 1, wherein calcium carbonate (CaCO₃) is the sparingly soluble salt.

3. The extinguishing agent as claimed in claim 1 wherein the extinguishing agent comprises the sparingly soluble salt in a proportion in the range from 5% by weight to 30% by weight.

4. The extinguishing agent as claimed in claim 1, wherein the sparingly soluble salt has an average particle size in the range from 0.2 μm to 10 μm.

5. A fire fighting system, comprising:
an extinguishing agent including:
at least water,
a salt which has a cation based on calcium, magnesium or strontium and is sparingly soluble in water, and
a water thickener.

6. A process for producing an extinguishing agent comprising water, a salt which is sparingly soluble in water and a water thickener, comprising:
dissolving the water thickener in water,
introducing the sparingly soluble salt, and
producing a suspension comprising the sparingly soluble salt and the water thickener.

7. The extinguishing agent as claimed in claim 1, wherein the extinguishing agent is configured to one or more of prevent fires and extinguish fires.

8. The extinguishing agent as claimed in claim 7, wherein the extinguishing agent is configured to extinguish a fire in a lithium ion battery.
